(19) United States
(12) Patent Application Publication
(10) Pub. No.: US 2015/0270633 A1
(43) Pub. Date: Sep. 24, 2015

(54) Connector Assembly

(71) Applicant: TYCO ELECTRONICS JAPAN G.K., Kanagawa (JP)

(72) Inventor: Yoshihiko Kodaira, Kanagawa (JP)

(73) Assignee: TYCO ELECTRONICS JAPAN G.K., Kanagawa (JP)

(21) Appl. No.: 14/667,126

(22) Filed: Mar. 24, 2015

(30) Foreign Application Priority Data
Mar. 24, 2014 (JP) 2014-059750

(51) Int. Cl. H01R 12/79; H01R 12/77; H01R 12/71

(52) U.S. Cl. CPC H01R 12/79; H01R 12/716; H01R 12/774

(57) ABSTRACT

A connector assembly is disclosed having a first connector and a complimentary second connector. The first connector has an approximate rectangular shape with four corners and two parallel long sides connected together at the four corners by a pair of two parallel short sides, and a catching member positioned on each of the four corners. The second connector is has mating portions at positions corresponding to the respective four corners of the first connector when the second connector is mated with the first connector. The mating portions are complimentary to the catching members, and when mated with the catching members, mate in a direction intersecting both the long and short sides intersecting at each of the four corners of the first connector.

### CROSS-REFERENCE TO RELATED APPLICATION

This application claims foreign priority under 35 U.S.C. §119(a)-(d) or (f) to Japanese Patent Application No. 2014-059750, dated Mar. 24, 2014.

### FIELD OF THE INVENTION

The invention is generally related to an electrical connector assembly, and, more specifically, to an impact resistance electrical connector assembly.

### BACKGROUND

In mobile phones, smart phones, and other similar devices, an electrical connector assembly is often used to connect a flexible printed circuit (“FPC”) to a circuit board. The connector assembly is required to be further reduced in size and height. The electrical connector assembly used in such applications is required to have a reliable locking mechanism where two connectors constituting the connector assembly maintain a locked state therebetween, even if subjected to an impact force. Additionally, the electrical connector assembly must meet an increasing market demand for electrical connector assemblies have smaller sizes and heights.

A conventional electrical connector assembly is disclosed in Japanese Patent Application No. 2011-228269A. The connector has an approximately rectangular shape in a plan view and a total of four locking metal fittings at positions near both end portions of two long sides of the connector.

Since the locking metal fittings are positioned on the long sides of the rectangular shape, the connector has impact resistance against an impact force acting in a direction of rotating the connector about one of the long sides serving as a rotation axis. However, the connector cannot withstand an impact force acting in a direction of rotating the connector about a perpendicularly positioned short side serving as a rotation axis.

Therefore, there is a need for an electrical connector assembly having a locking mechanism which can withstand an impact force from any direction.

### SUMMARY

A connector assembly has a first connector and a complimentary second connector. The first connector has an approximate rectangular shape with four corners and two parallel long sides connected together at the four corners by a pair of two parallel short sides, and a catching member positioned on each of the four corners. The second connector is has mating portions at positions corresponding to the respective four corners of the first connector when the second connector is mated with the first connector. The mating portions are complimentary to the catching members, and when mated with the catching members, mate in a direction intersecting both the long and short sides intersecting at each of the four corners of the first connector.

### BRIEF DESCRIPTION OF THE DRAWINGS

The invention will now be described by way of example, with reference to the accompanying Figures, of which:

FIG. 1 is a perspective view of a first side of a connector assembly of a first embodiment having a plug connector and a receptacle connector;

FIG. 2 is a perspective view of a second side of the plug connector;

FIG. 3(A) is a perspective view of a first side of a first metal fitting catch positioned on the plug connector;

FIG. 3(B) is a perspective view of a second side of the first metal fitting catch positioned on the plug connector;

FIG. 4(A) is a perspective view of a first side of a complementary first metal fitting latch positioned on the receptacle connector;

FIG. 4(B) is a perspective view of a second side of the first metal fitting latch positioned on the receptacle connector;

FIG. 5(A) is a perspective view of the plug connector positioned proximate to the receptacle connector before being mated together;

FIG. 5(B) is a perspective view of the first metal fitting catches positioned proximate to the first metal fitting latches before the plug connector is mated with the receptacle connector;

FIG. 6(A) is a perspective view of the plug connector mated with the receptacle connector;

FIG. 6(B) is a perspective view of the first metal fitting catches mated with the first metal fitting latches when the plug connector is mated with the receptacle connector;

FIG. 7(A) is a perspective view of a first side of a second metal fitting catch positionable on a plug connector in a connector assembly of a second embodiment;

FIG. 7(B) is a perspective view of a second side of the second metal fitting catch;

FIG. 8(A) is a perspective view of the second metal fitting catch positioned proximate to the first metal fitting latch before being mated together;

FIG. 8(B) is a perspective view of the second metal fitting catch mated with the first metal fitting latch;

FIG. 9(A) is a perspective view of a first side of a second metal fitting latch positionable on a receptacle connector in a connector assembly of a third embodiment;

FIG. 9(B) is a perspective view of a second side of the second metal fitting latch;

FIG. 10(A) is a perspective view of the second metal fitting catch positioned proximate to the second metal fitting latch before being mated together;

FIG. 10(B) is a perspective view of the second metal fitting catch mated with the second metal fitting latch;

FIG. 11(A) is a perspective view of a first side of a third metal fitting catch positionable on a plug connector in a connector assembly of a fourth embodiment;

FIG. 11(B) is a perspective view of a second side of the third metal fitting catch;

FIG. 12(A) is a perspective view of the third metal fitting catch positioned proximate to the first metal fitting latch before being mated together;

FIG. 12(B) is a perspective view of the third metal fitting catch mated with the first metal fitting latch;

FIG. 13(A) is a perspective view of a first side of a fourth metal fitting catch positionable on a plug connector in a connector assembly of a fifth embodiment;

FIG. 13(B) is a perspective view of a second side of the fourth metal fitting catch;

FIG. 14(A) is a perspective view of the fourth metal fitting catch positioned proximate to the first metal fitting latch before being mated together;

FIG. 14(B) is a perspective view of the fourth metal fitting catch mated with the first metal fitting latch;

FIG. 15(A) is a perspective view of a first side of a fifth metal fitting catch positionable on a plug connector in a connector assembly of a sixth embodiment;

FIG. 15(B) is a perspective view of a second side of the fifth metal fitting catch;

FIG. 16(A) is a perspective view of a first side of a third metal fitting latch positionable on a receptacle connector in the connector assembly of the sixth embodiment;

FIG. 16(B) is a perspective view of a second side of the third metal fitting latch;

FIG. 17(A) is a perspective view of the fifth metal fitting catch positioned proximate to the third metal fitting latch before to being mated together;

FIG. 17(B) is a perspective view of the fifth metal fitting catch mated with the third metal fitting latch;

FIG. 18(A) is a perspective view of a first side of a sixth metal fitting catch positionable on a plug connector in a connector assembly of a seventh embodiment;

FIG. 18(B) is a perspective view of a second side of the sixth metal fitting catch;

FIG. 19(A) is a perspective view of the sixth metal fitting catch positioned proximate to the third metal fitting latch before being mated together;

FIG. 19(B) is a perspective view of the sixth metal fitting catch mated with the third metal fitting latch;

FIG. 20 is a perspective view of a first side of a plug connector and a receptacle connector before being mated together, constituting a connector assembly of an eighth embodiment;

FIG. 21 is a perspective view of a second side of the plug connector in FIG. 20;

FIG. 22 is a perspective view of a first side of a plug connector and a receptacle connector before being mated together, constituting a connector assembly of a ninth embodiment;

FIG. 23 is a perspective view of the first side of the plug connector and the receptacle connector before being mated together, constituting the connector assembly of the ninth embodiment;

FIG. 24(A) is a cross-sectional view taken along arrow A-A shown in FIG. 23 of the plug connector positioned proximate to the receptacle connector before being mated together; and

FIG. 24(B) is a cross-sectional view taken along arrow A-A shown in FIG. 23 of the plug connector mated to the receptacle connector.

### DETAILED DESCRIPTION OF THE PREFERRED EMBODIMENT(S)

An object of the invention is to address and overcome the disadvantages discussed above.

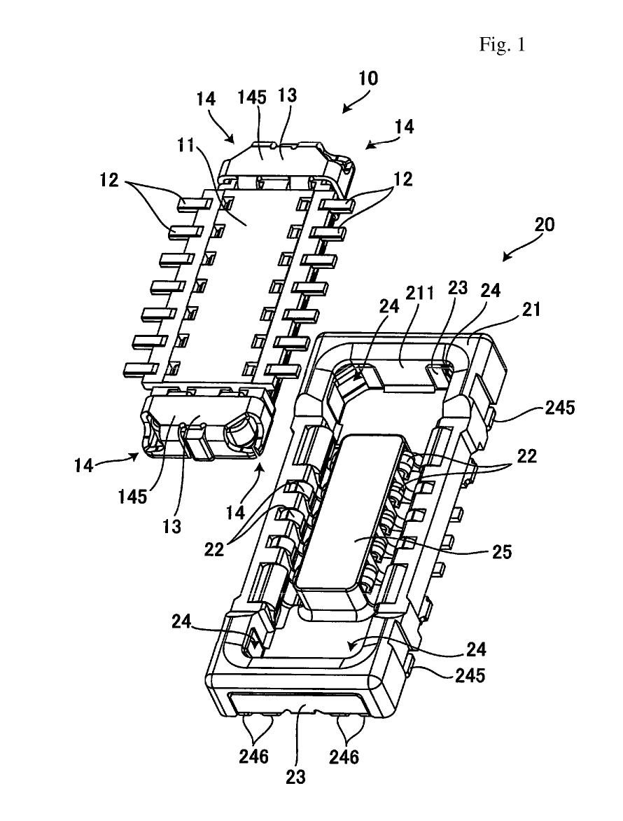

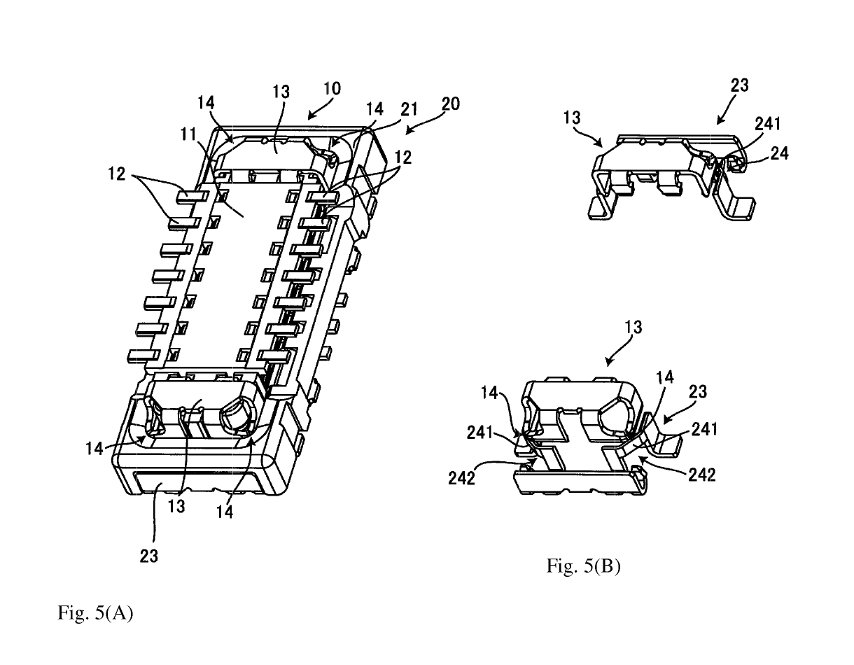

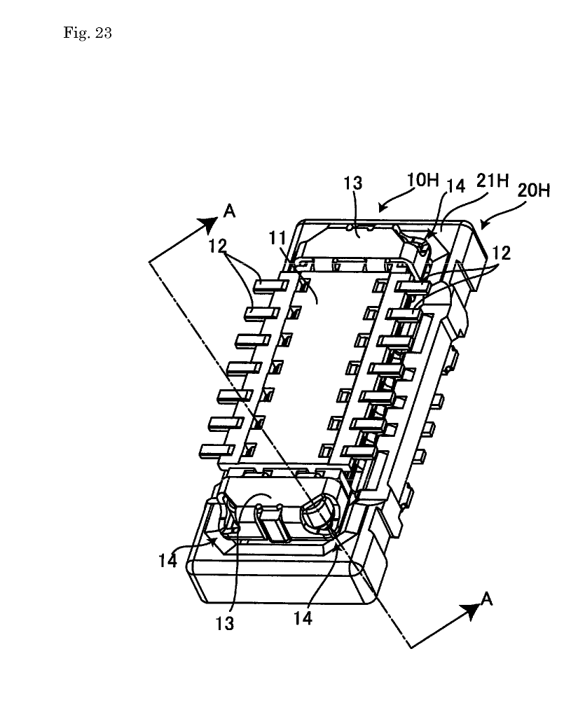

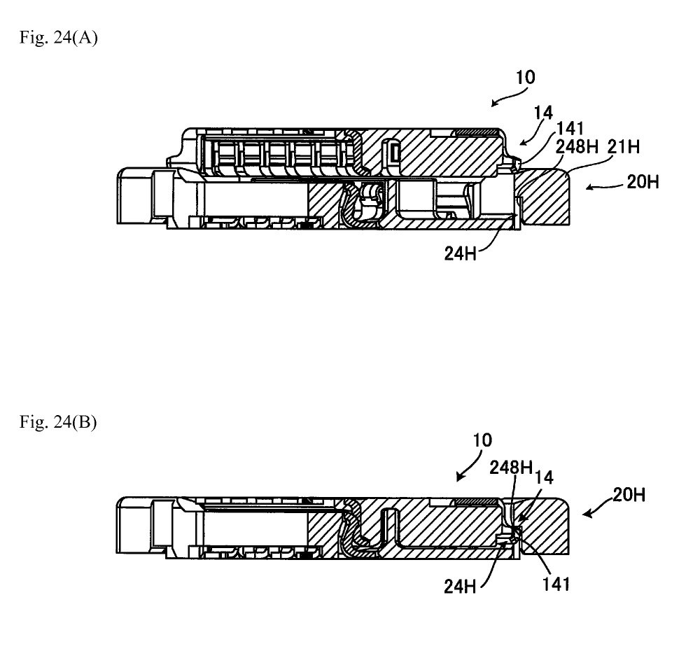

Exemplary embodiments of the invention will be described below with reference to FIGS. 1-24(B).

The plug connector 10 and the receptacle connector 20 in FIG. 1 correspond to respective embodiments of the first connector and the second connector discussed below. However, one of ordinary skill in the art would appreciate that the plug and receptacle connectors 10,20 may be embodied in many different forms.

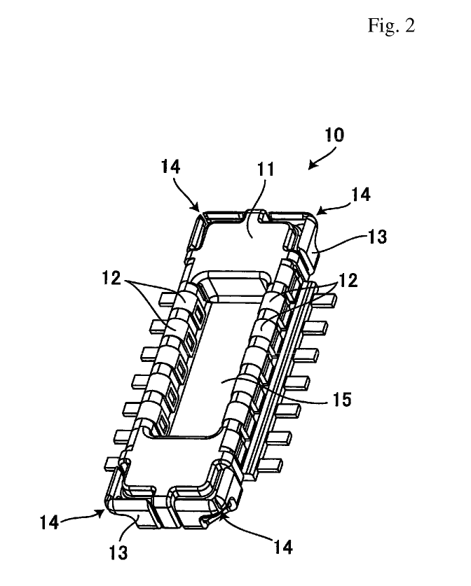

In the embodiments of FIGS. 1 and 2, the plug connector 10 has a plug housing 11 with an approximately rectangular shape in a plan view, and with an approximately rectangular shape as a whole. Since the plug housing 11 has an approximately rectangular shape, the plug housing 11 has two parallel long sides connected together at opposite ends by a pair of two parallel short sides. A receiving cavity 15 having an approximately rectangular shape is positioned in a central portion of the plug housing 11. A bottom surface of the receiving cavity 15 is substantially planar and can be utilized as a suction surface.

The plug connector 10 has a plurality of contacts 12 positioned along the two long sides of the plug housing 11. The contacts 12 are connected to connection pads on a FPC (not shown). A metal fitting catch 13 is positioned on each of the short sides at both ends of the plug connector 10. Each metal fitting catch 13 has two catching members 14 positioned on two corner portions. When a metal fitting catch 13 is positioned on the two opposite ends of the plug connector 10, the catching members 14 may engage the receptacle connector 20 during mating, where one catching member 14 is positioned at each of the four corners of the plug housing 11.

In the embodiments of FIGS. 1 and 2, the plug connector 10 has two first metal fitting catches 13. These two first metal fitting catches 13 have identical shapes, but are mirror images of the each other.

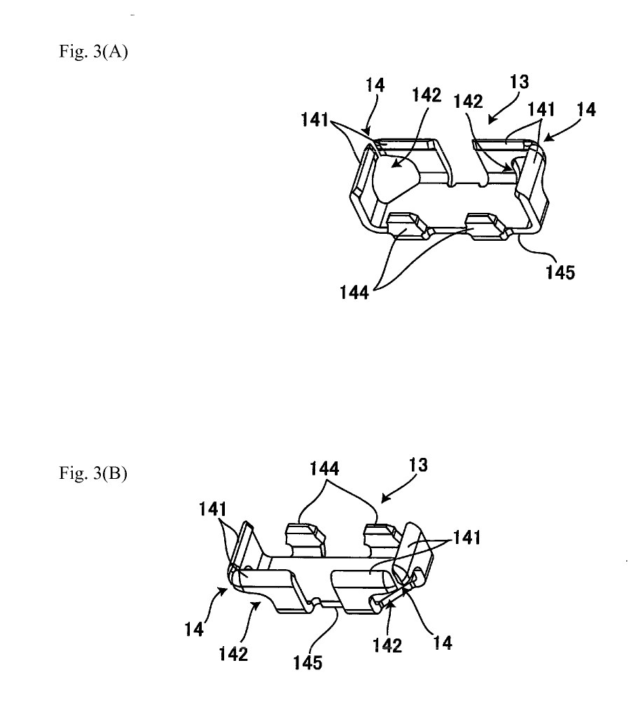

In the embodiments of FIGS. 3(A) and 3(B), the first metal fitting catch 13 is shown being removed from the plug housing 11 of the plug connector 10.

Each first metal fitting catch 13 has a base 145 with two first catching members 14, with one first catching member 14 being positioned on each opposite corner. Each first catching member 14 has two cantilevered first arms 141 with fixed ends positioned on two side edges forming each corner. The two first arms 141 flank each corner, with their opposite free ends extending outward from the base 145 of the first metal fitting catch 13, and extending towards each other. Each first catching member 14 has a recessed portion 142 positioned adjacent to and extending between the fixed ends of the two first arms 141. The two cantilevered first arms 141 are elastically deformed when the plug connector 10 and the receptacle connector 20 are mated with or unmated from each other. The base 145 of the first metal fitting catch 13 is soldered to an FPC on which the plug connector 10 is mounted. Further, two press-fitting pieces 144 that are press-fitted into the plug housing 11 extend from one end of the base 145.

In an embodiment of FIG. 1, the receptacle connector 20 has a receptacle housing 21 with a plug connector receiving space 211 for receiving the plug connector 10 therein. The plug connector receiving space 211 is complimentary to the shape of the plug connector 10, having an approximate rectangular shape with two parallel long sides connected together at opposite ends by a pair of two parallel short sides. A plurality of contacts 22 are positioned on the receptacle connector 20 at various positions thereof, the positions corresponding to the plurality of contacts 12 of the plug connector 10 when the plug connector 10 is received in the plug connector receiving space 211. A contacting end of the plurality of contacts 22 is partially received in contact receiving spaces within a platform portion 25 of the receptacle housing 21 positioned in a central region of the plug connector receiving space 211. An opposite terminating end of the contacts 22 are soldered to conductor patterns of a circuit board (not shown). Therefore, when the plug connector 10 and the receptacle connector 20 are mated with each other, wirings on the FPC connected with the plug connector 10 are electrically connected to the conductor patterns formed on the circuit board on which the receptacle connector 20 is mounted. An outer facing surface of the platform portion 25 is planar and may be utilized as a suction face.

As shown in an embodiment of FIG. 1, one first metal fitting latch 23 is positioned on each of the short sides at opposite ends of the plug connector receiving space 211. Each of the two first metal fitting latches 23 has two mating portions 24 positioned opposite each other.

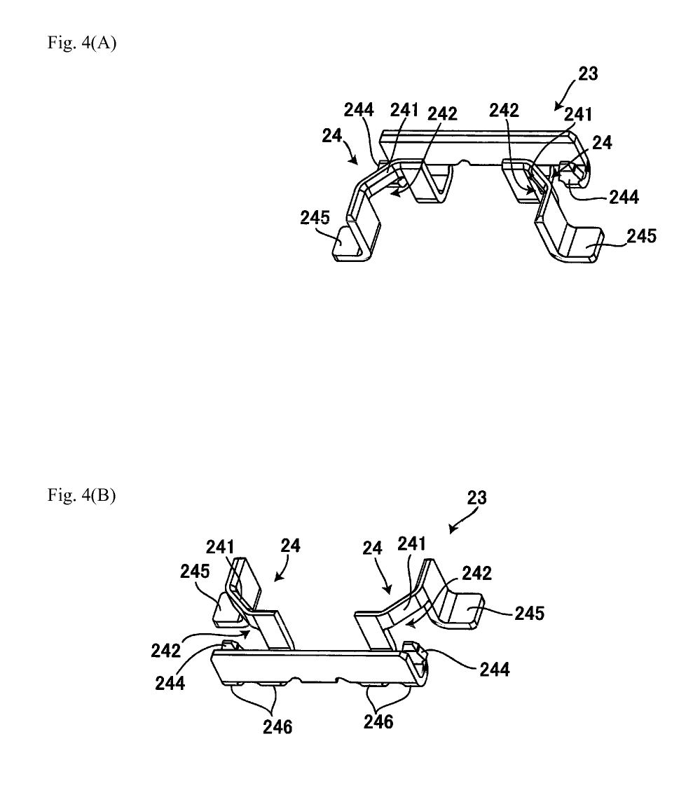

As shown in the embodiments of FIGS. 4(a) and 4(B), the mating portions 24 are positioned at the four corners of the plug connector receiving space 211, namely, at respective corners corresponding to the respective four corners of the plug connector 10 when the receptacle connector 20 and the plug connector 10 have been mated with each other.

As shown in the embodiment of FIG. 1, the receptacle connector 20 has two first metal fitting latches 23. As shown in the embodiments of FIGS. 4(A) and 4(B), these two first metal fitting latches 23 have identical shapes, but are mirror images of the each other.

Each first metal fitting latch 23 has two mating portions 24. Each mating portion 24 has a latching wall 241 positioned to face a corner of the plug connector 10 having the catching member 14. Additionally, each latching wall 241 is upstanding in a direction intersecting both of two sides of the plug connector 10 sandwiching the corner. A catching member receiving space 242, in which the catching member 14 of the plug connector 10 is received upon mating, is positioned on a lower portion of the latching wall 241. Connecting feet 245 and 246 to be soldered to a circuit board on which the receptacle connector 20 is mounted, are positioned on opposite ends of the first metal fitting latch 23. It should be noted that two press-fitting pieces 244 to be press-fitted into the receptacle housing 21 are positioned on each first metal fitting latch 23.

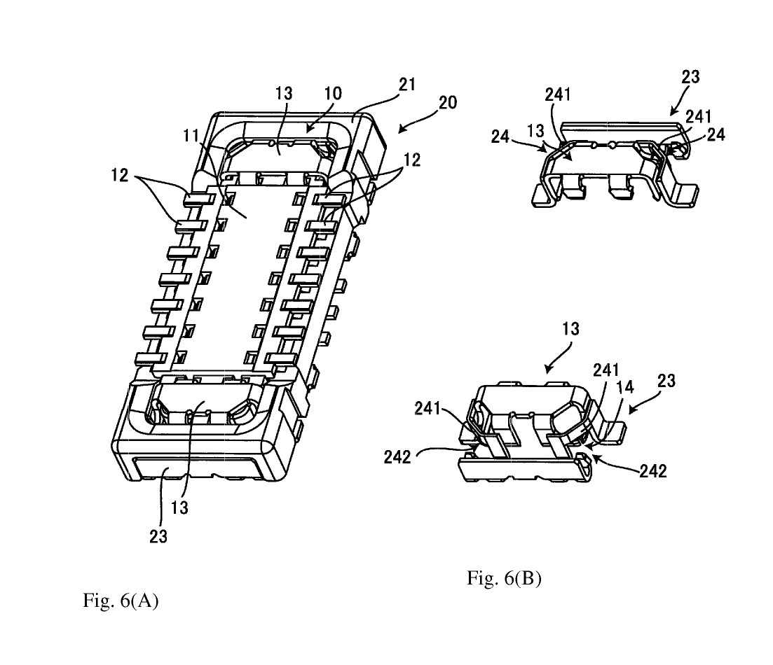

During mating of the plug connector 10 to the receptacle connector 20, the two first arms 141 of one of the catching members 14 of the plug connector 10 each contact one of the two latching walls 241 on the first metal fitting latch 23. The first arms 141 are elastically displaced, sliding over the latching walls 241 to enter into the catching member receiving spaces 242 of the mating portion 24. As the first arms 141 enter the catching member receiving spaces 242, the two first arms 141 elastically relax. Thereby, the plug connector 10 is mated with the receptacle connector 20, as shown in the embodiments of FIGS. 6(A) and 6(B).

Here, as described above, the catching member 14 of the plug connector 10 has two first arms 141 having such shapes that the fixed ends thereof extend from two sides sandwiching a corner of the plug housing 11, and the free ends thereof extend towards each other, as shown in the embodiment of FIG. 3. That is, the catching member 14 has a shape where it projects so as to intersect both the two sides. Correspondingly, the mating portion 24 of the receptacle connector 20 includes the latching wall 241 standing so as to intersect both the two sides, and the catching member receiving space 242 positioned thereon. Therefore, the catching member 14 engages the mating portion 24 so as to intersect these two sides. Thus, a connector assembly having the plug connector 10, the receptacle connector 20 and the above described latching mechanism can withstand an impact from any direction.

Additional embodiments of the electrical connector assembly will now be described below, However, only different elements and components will be described, while the Figures showing different elements and components from the previously-described embodiments such as the first embodiment or the like are shown. Parts or elements corresponding to respective parts or elements in the above described first embodiment are denoted by reference numerals obtained by further attaching such an alphabet as A, B and the like to the reference numerals attached to the respective parts or elements in the first embodiment, and explanations thereof will be omitted in some cases.

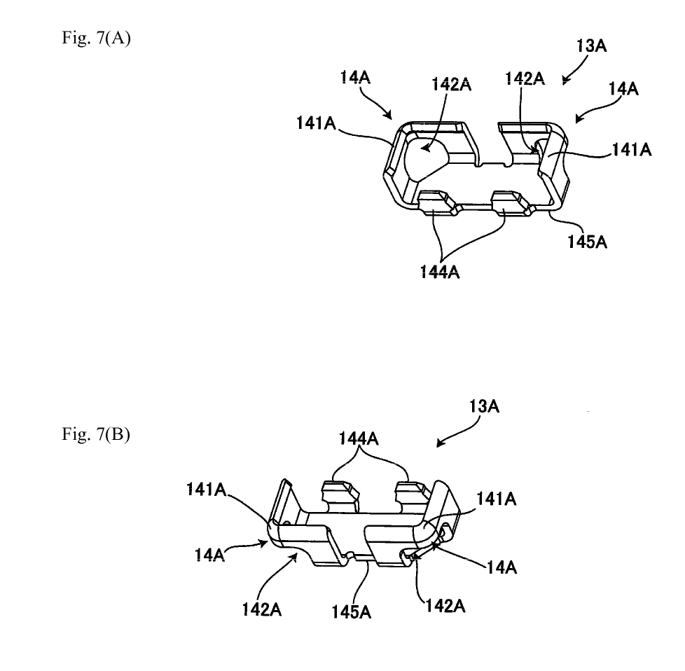

A different point of the connector assembly of the second embodiment described here from the connector assembly of the above described first embodiment is only the second metal fitting catch shown in an embodiment of FIGS. 7(A) and 7(B). Therefore, here, explanation about the metal fitting catch is substituted for explanation about the connector assembly of the second embodiment.

The first metal fitting catch 13 of the plug connector 10 constituting the connector assembly of the above described first embodiment is configured such that one catching member 14 has two first arms 141. In a second embodiment shown in FIGS. 7(A) and 7(B), the second metal fitting catch 13A each second catching member 14A has one second arm 141A with a shape bent so as to form a corner. The second arm 141A has a continuous annular shape in which the two first arms 141 in the first embodiment have been connected to each other. Therefore, the second arm 141A, together with the base 145A, recessed portion 142A whose periphery has an annular shape.

In the second embodiment, the annular shape of the second catching member 14A results in a limited elasticity during mating. Therefore, the receptacle connector 20 having the second catching member 14A of the second embodiment is satisfactory when repetition of mating and disengaging with the plug connector 10 is not required.

When the second metal fitting catch 13A and first metal fitting latch 23 are mated with each other, the second arms 141A of the second metal fitting catch 13A is positioned in the catching member receiving space 242 of the first metal fitting latch 23, with the second arm 141A being engaged with the latching wall 241. When the second metal fitting catch 13A of the plug connector 10 is mated with the first metal fitting latch 23 of the receptacle connector 20, both the second metal fitting catch 13A and the first metal fitting latch 23 have low elasticity. Therefore, a large mating force is required to displace the latching wall 241 or the like.

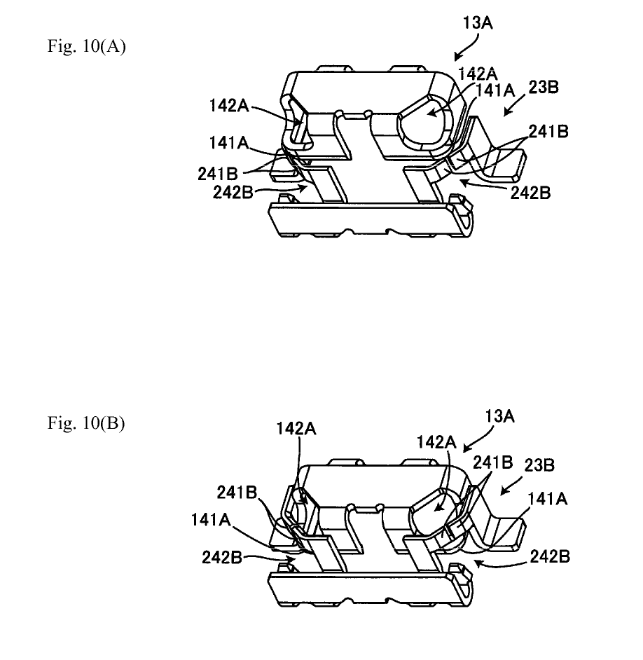

In a third embodiment of the connector assembly shown in FIGS. 10(A) and 10(B), a metal fitting catch identical to the second metal fitting catch 13A in the second embodiment shown in FIGS. 7(A) and 7(B) is used as a second metal fitting catch positioned on in the plug connector 10.

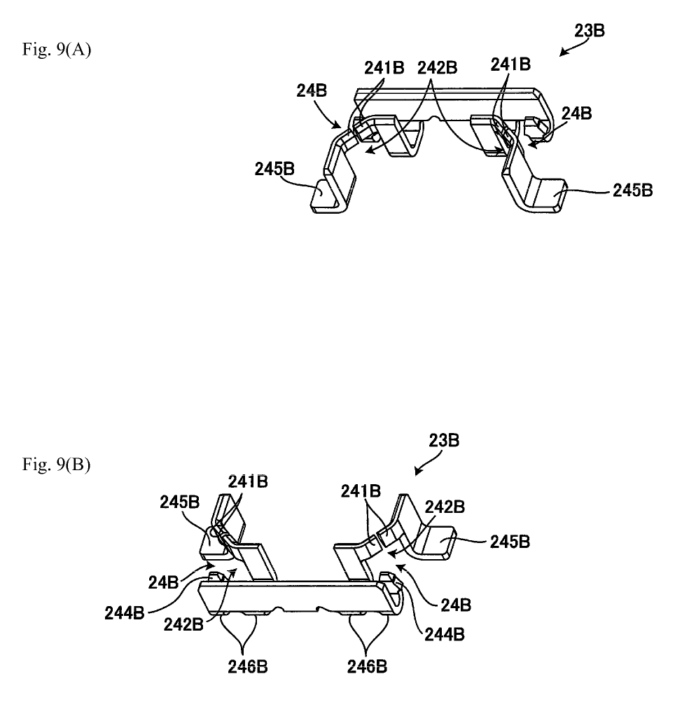

A second metal fitting latch 23B of a third embodiment shown in FIGS. 9(A) and 9(B) has latching walls 241B with a shape obtained by splitting the latching wall 241 in the first metal fitting latch 23 in the first embodiment into two pieces. A catching member receiving space 242B is similar to the catching member receiving space 242 in the first embodiment.

As shown in the embodiment of FIGS. 10(A) and 10(B), when the second metal fitting catch 13A and the second metal fitting latch 23B are mated with each other, the second arms 141A of the second metal fitting catch 13A are fitted into the catching member receiving spaces 242B of the second metal fitting latch 23B, engaging with the latching walls 241B.

Similar to that of the first embodiment, when the second metal fitting catch 13A of the plug connector 10 is mated with the second metal fitting latch 23B of the receptacle connector 20, the latching walls 241B of the second metal fitting latch 23B elastically deform. Therefore, the connector assembly of the third embodiment is also suitable for an application where mating and unmated between the plug connector and the receptacle connector are repeated like the connector assembly of the above described first embodiment.

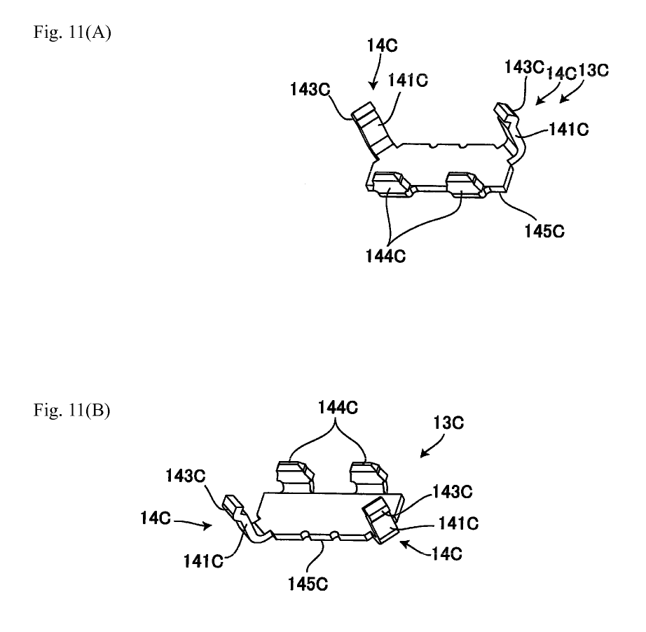

A third metal fitting catch 13C in a fourth embodiment shown in FIGS. 11(A) and 11(B) has two third catching members 14C, each having one cantilevered third arm 141C positioned on opposite corners of the third base 145C. The third arm 141C extends away from the third base 145C in an inclined fashion to an approximately rectangular shape of the plug connector in a plan view, and has a bent projection portion 143C positioned proximate to a free end thereof. The bent projection portion 143C projects outward in a direction perpendicular to a surface of the third base 145C.

When the third metal fitting catch 13C is mated with the first metal fitting latch 23, the bent projection portions 143C are positioned in the catching member receiving spaces 242 while the third arms 141C of the third metal fitting catch 13C are being elastically deformed by the latching walls 241, in a manner substantially similar as described in the first embodiment for the first arms 141. The bent projection portions 143C are retained in the catching member receiving spaces 242 by the latching walls 241. A mating direction of the bent projection portion 143C being mated into the catching member receiving space 242 is a direction inclined to the approximately rectangular shape of the plug connector in a plan view like the above described first to third embodiments.

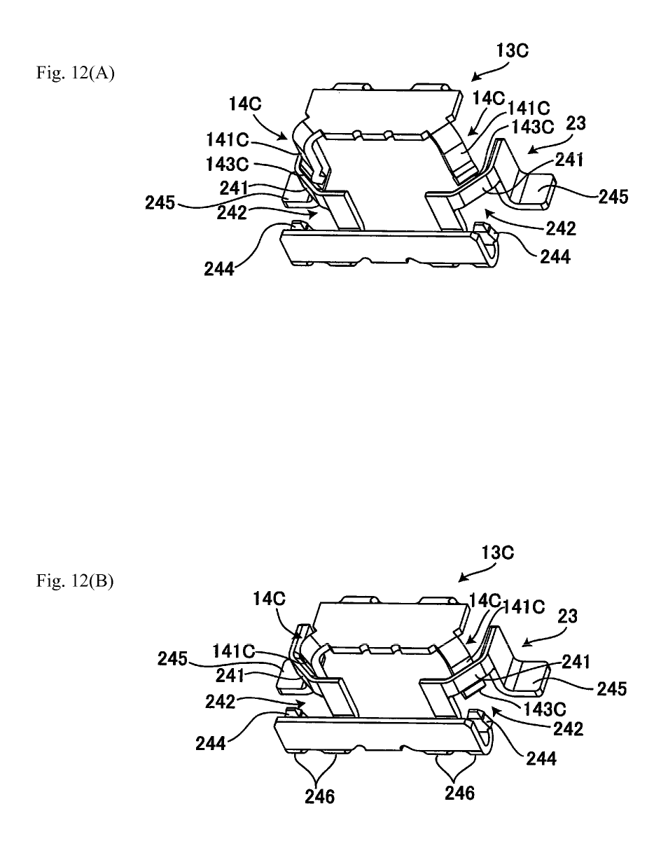

Since the connector assembly of the fourth embodiment is configured such that the third arm 141C is elastically deformed by the latching wall 241 during mating, it is also suitable for an application where mating and unmating are repeated, similar to the connector assemblies of the first embodiment and the third embodiment. See FIGS. 12(A) and 12(B).

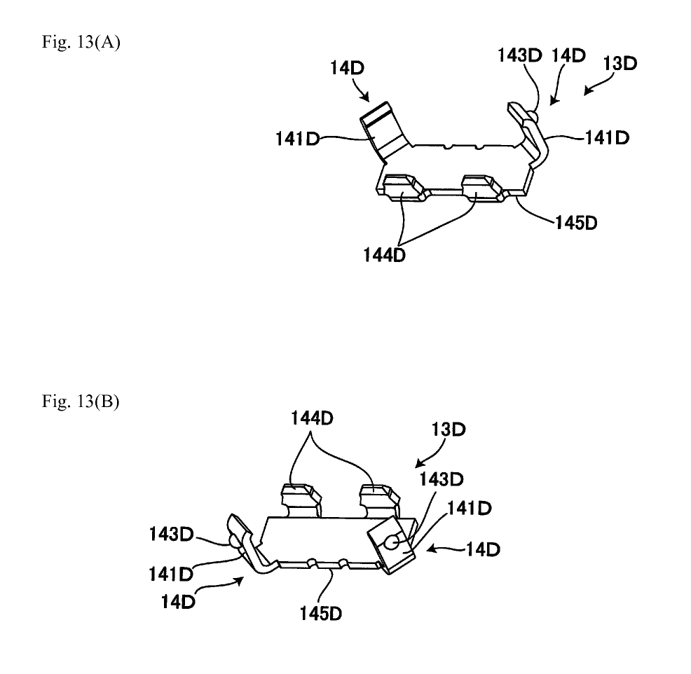

A fourth metal fitting catch 13D in a fifth embodiment shown in FIGS. 13(A) and 13(B) has two fourth catching members 14D, each having one cantilevered fourth arm 141D positioned on opposite corners of a fourth base 145D. Each fourth arm 141D projects outward in a similar fashion as the third arms 141C in the third embodiment shown in FIGS. 11(A) and 11(B). The fourth arm 141D has a semi-spherical projecting pad 143D positioned on an outer facing surface (not labeled) of a free end thereof, projecting outwardly from the outer facing surface. It should be noted that while the projecting pad 143D is shown as being semi-spherical, those of ordinary skill in the art would appreciate that projecting pad 143D may have a rectangular shape or other shapes that would be complimentary to the shape of the catching member receiving spaces 242 on the first metal fitting latch 23.

When the fourth metal fitting catch 13D is mated with the first metal fitting latch 23, the projecting pads 143D are received into the catching member receiving spaces 242 while the fourth arms 141D of the fourth metal fitting catch 13D are being elastically deformed by the latching walls 241, in a manner substantially similar as described in the first embodiment for the first arms 141. Thereby, the projecting pads 143D are retained in the catching member receiving spaces 242 by the latching walls 241. A mating direction of the projection portion 143D into the catching member receiving space 242 is a direction inclined to the rectangular shape of the plug connector in a plan view like the cases of the first to fourth embodiments described above.

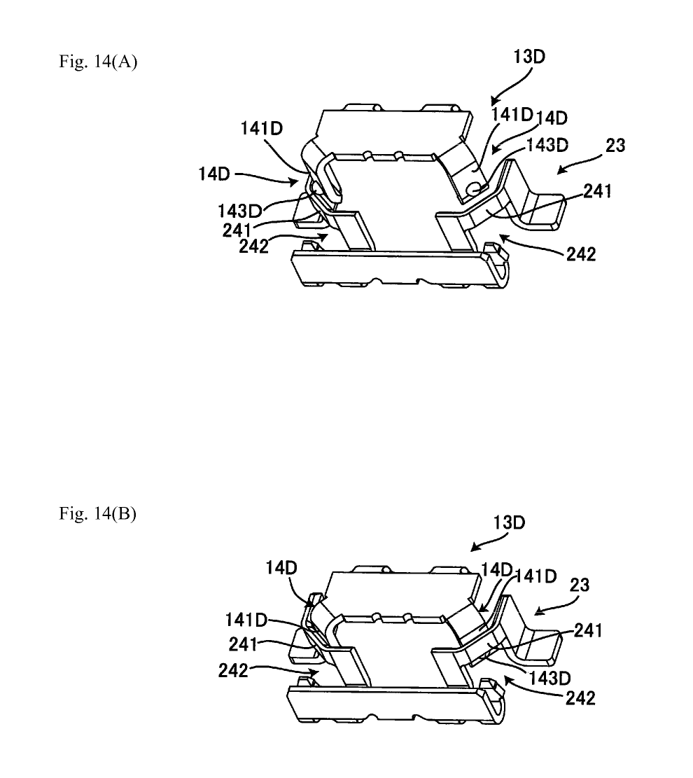

Since the connector assembly of the fifth embodiment is also configured such that the catching pads 141D are elastically deformed like the above described fourth embodiment, it is also suitable for an application where mating and unmating are repeated, similar to the connector assemblies of the first embodiment and the third embodiment. See FIGS. 14(A) and 14(B).

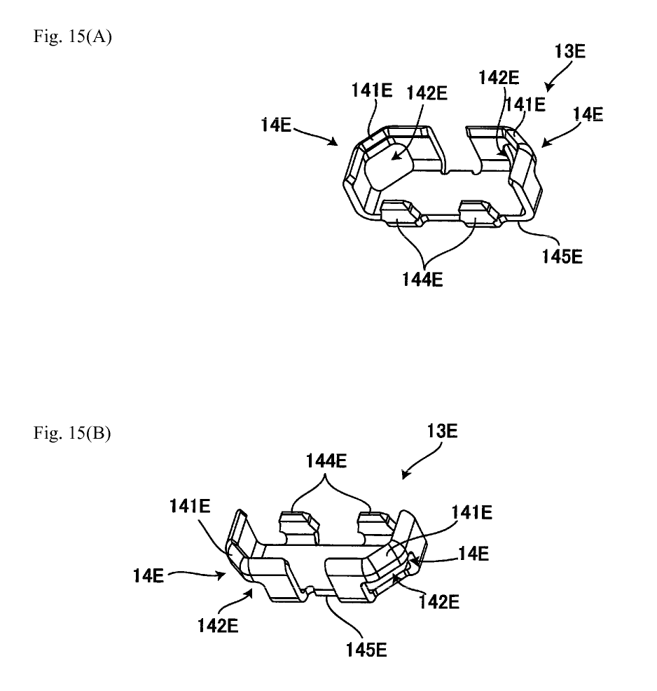

A fifth metal fitting catch 13E of a sixth embodiment shown in FIGS. 15(A) and 15(B) has two fifth catching members 14E. One fifth catching member 14E is positioned on an opposite corner of the fifth metal fitting catch 13E, extending from a fifth base 145E thereof. Each fifth catching member 14E has a catching wall 141E extending obliquely across a corner of the fifth metal fitting catch 13E. Each catching wall 141E has a recessed portion 142E, and an inwardly overhanging engaging lip (not labeled) extending along a length of the catching wall 141E.

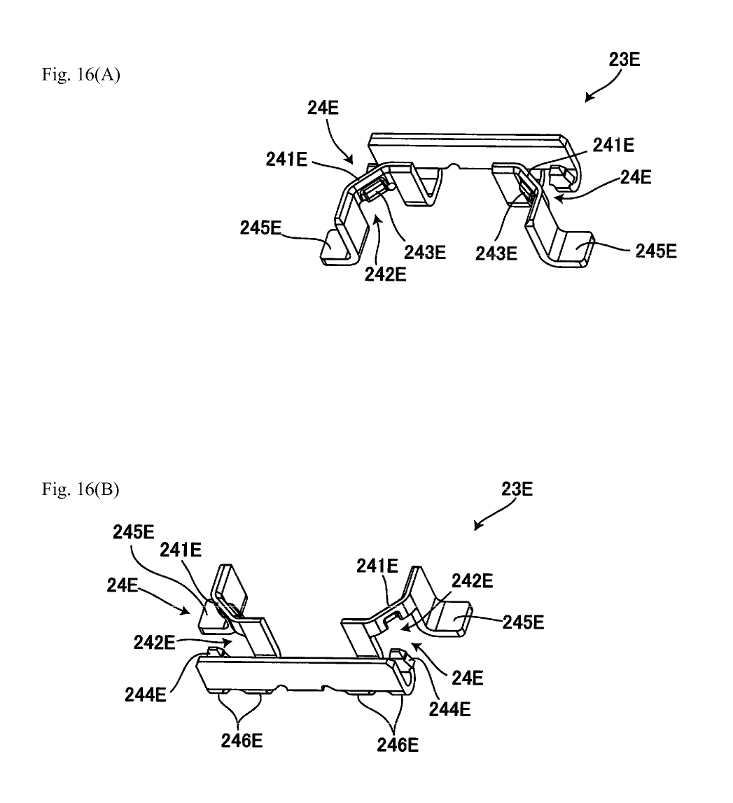

The third metal fitting latch 23E of the sixth embodiment is shown in FIGS. 16(A) and 16(B), and has two third mating portions 24E. Each third mating portion 24 has a third latching wall 241E positioned to face a corner of the plug connector 10 having the fifth catching member 14E. A mating projection portion 243E is positioned on an inner facing surface of the latching wall 241E, projecting inwardly.

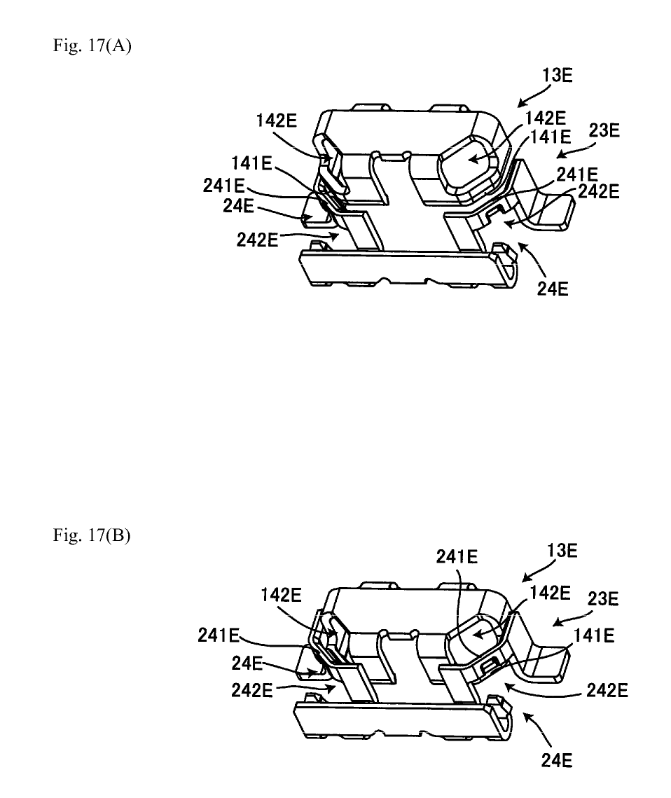

In FIGS. 17(A) and 17(B), an aspect of mating the fifth metal fitting catch 13E shown in FIG. 15 and the third metal fitting latch 23E shown in FIGS. 16(A) and 16(B) with each other is shown.

When the fifth metal fitting catch 13E is mated with the third metal fitting latch 23E, the latching walls 141E of the fifth metal fitting catch 13E are received into the catching member receiving spaces 242E of the third metal fitting latch 23E, so that the latching walls 141E catch on the mating projection portions 243E. A mating direction of the catching wall 141E into the catching member receiving space 242E is a direction inclined to the approximately rectangular shape of the plug connector in a plan view like the respective embodiments described above.

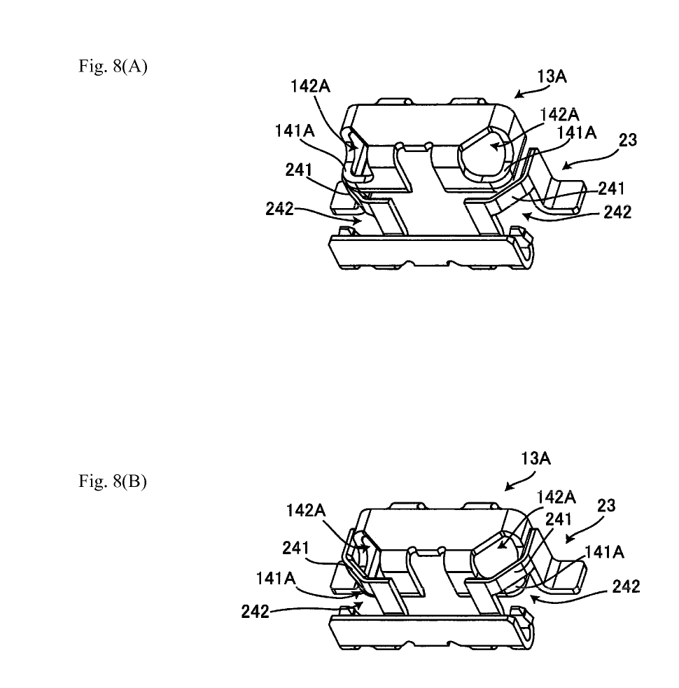

In the sixth embodiment, the elasticity of the fifth metal fitting catch 13E or the third metal fitting latch 23E is substantially similar to the above described second embodiment (see FIGS. 7(A),7(B) and FIGS. 8(A),8(B)). That is, in the case of the sixth embodiment, both the fifth metal fitting catch 13E and the third metal fitting latch 23E have low elasticity. Therefore, a large mating force is required to displace the latching wall 241E or the like. Like the above, the aspect of the sixth embodiment can be adopted in the case of a connector assembly where repetition of mating and unmating is not required.

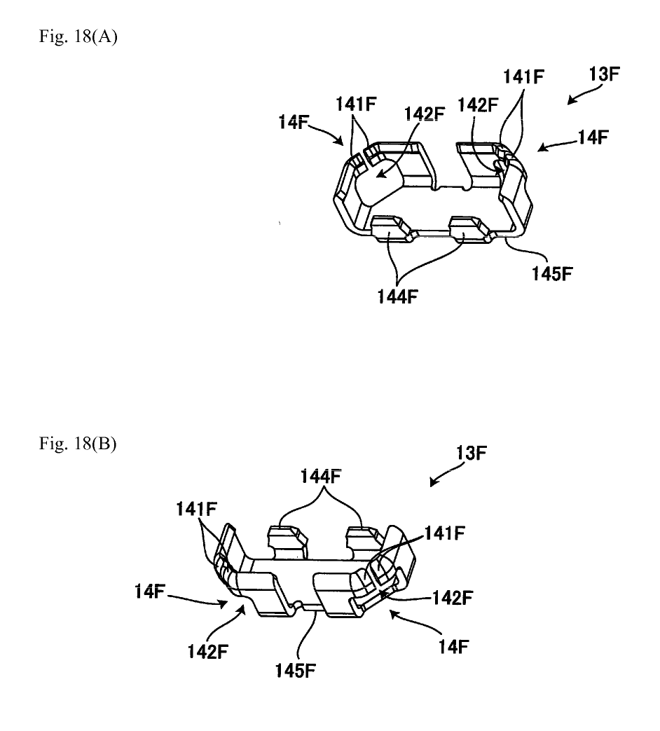

A sixth metal fitting catch 13F of a seventh embodiment is shown in FIGS. 18(A) and 18(B), differing from the fifth metal fitting catch 13E shown in FIGS. 15(A) and 15(B) in such a point that the catching wall 141E has been divided into two catching walls 141F split at a central portion. Similar to the first metal fitting catch 13 of FIGS. 3(A) and 3(B), the sixth catching members 14 each have two cantilevered sixth arms 141F with fixed ends positioned on two side edges forming each corner. The two sixth arms 141F flank each corner, with their opposite free ends extending outward from the base 145F, extending towards each other. The other components and elements of the sixth metal fitting catch 13F are substantially identical to those of the fifth metal fitting catch 13E shown in FIGS. 15(A) and 15(B).

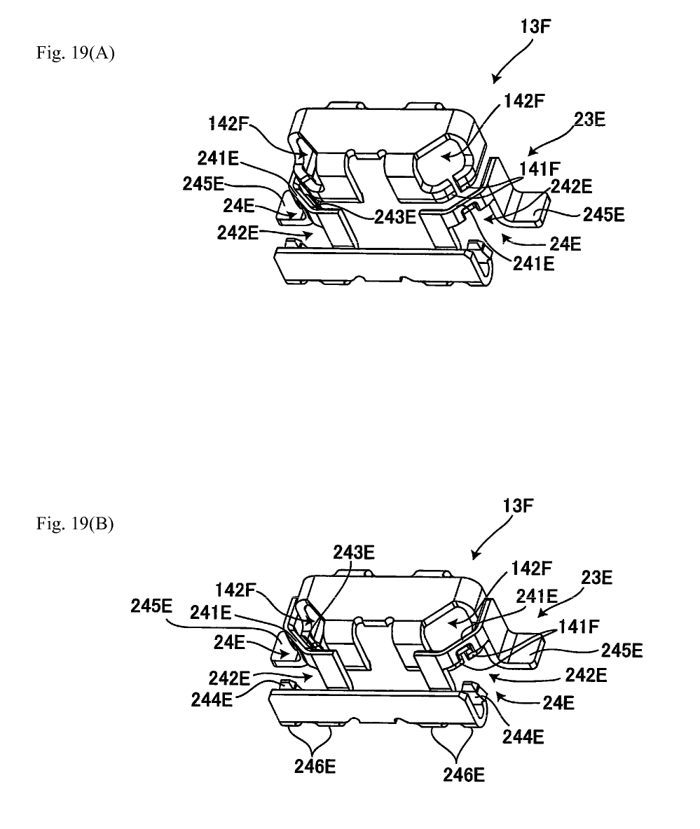

As shown in FIGS. 19(A) and 19(B), when the sixth metal fitting catch 13F is mated with the third metal fitting latch 23E, two split catching walls 141F of the sixth metal fitting catch 13F are received into the catching member receiving space 241E of the third metal fitting latch 23E while they are being elastically deformed. The catching walls 141F engage the catching member receiving space 243E and are retained therein by also engaging the third latching wall 241E. A mating direction of the catching walls 141F into the catching member receiving space 242E is a direction inclined to the approximately rectangular shape of the plug connector in a plan view like the respective embodiments described above.

In the sixth embodiment, when the sixth metal fitting catch 13F of the plug connector 10 is mated with the third metal fitting latch 23E of the receptacle connector 20, the catching walls 141F of the sixth metal fitting catch 13F are elastically deformed by the third latching walls 241E. Therefore, the connector assembly of the seventh embodiment is also suitable for a connector assembly where mating and unmating are repeated.

Here, the various connector assemblies from the first embodiment to the seventh embodiment described above are directed to examples where the metal fitting catch is provided in the plug connector while the metal fitting latch is provided in the receptacle connector.

Embodiments where the housing of the plug connector or the housing of the receptacle connector is utilized as the catching member or the mating portion will be described below.

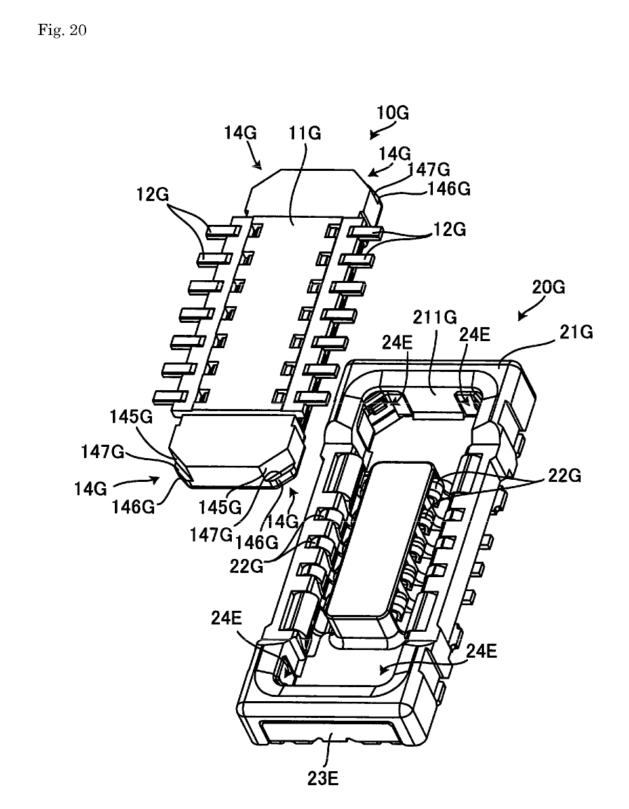

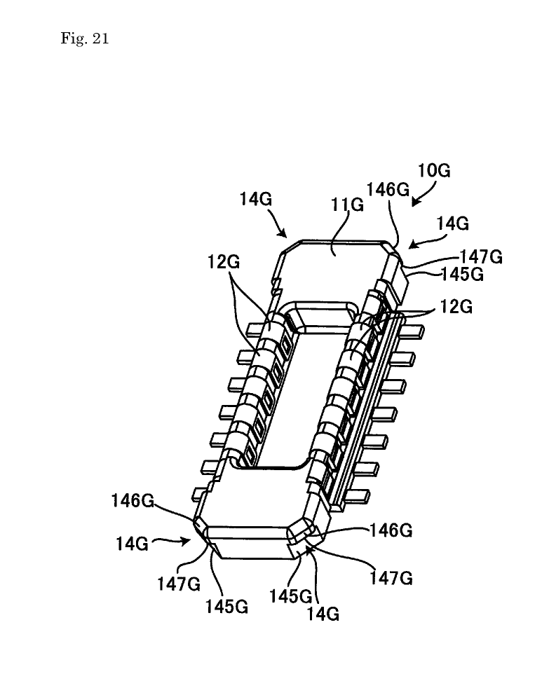

In the plug connectors constituting the connector assemblies of the first to seventh embodiments described above, the metal fitting catches 13 to 13F are used, and the catching members 14 to 14F are positioned on the metal fitting catch 13 to 13F. However, a plug connector 10G, constituting the connector assembly of an eighth embodiment shown in FIGS. 20 and 21, has seventh catching members 14G positioned on a plug housing 11G itself. The seventh catching members 14G are positioned on four corners of an approximately rectangular shape of the plug housing 11G in a plan view, respectively. On two opposite corners of each seventh catching member 14G, the seventh catching member 14G has a standing wall portion 145G positioned diagonally across the corner, and a catching projection portion 146G extending along a base end of the standing wall portion 145G and projecting outward, diagonally across the corner. Further, an engaging surface 147G of the catching projection portion 146G extends from an outer edge thereof to an outer facing surface of the standing wall portion 145G.

Mating portions 24E complementary to the seventh catching members 14G are positioned in a plug connector receiving space 211G of a receptacle housing 21G by the third metal fitting latch 23E.

In the connector assembly of the eight embodiment, when the plug connector 10G is mated with the receptacle connector 20G, the catching projection portions 146G are fitted into catching member receiving spaces 242E of the mating portions 24E of the third metal fitting latch 23E shown in FIGS. 6(A) and 6(B). The catching projection portions 146G engage the mating projection portions 243E and are retained thereby. A mating direction of the catching projection portion 146G in the catching member receiving space 242E is a direction inclined to an approximately rectangular shape of the plug connector 10G in a plan view like the respective embodiments described above.

In the eighth embodiment, like the above described sixth embodiment (see FIGS. 15(A) to 17(B)), when the plug connector 10G is mated with the receptacle connector 20G, the third metal fitting latch 23E has a low elasticity. Further, in the plug connector 10G, the seventh catching members 14G are positioned on the plug housing 11G itself. Therefore, the eighth embodiment is generally unsuitable for an application where mating/unmating of the plug connector with/from the receptacle connector is performed in a repeated manner. However, the eighth embodiment is generally suitable for applications where mating is only needed to be performed once.

In a ninth embodiment, the plug connector 10 is a connector identical to the connector 10 (see FIGS. 1 and 2) of the above described first embodiment. Therefore, the first metal fitting catches 13 shown in FIGS. 3(A) and 3(B) are used in this plug connector 10, and the catching members 14 are formed by the first metal fitting catch 13.

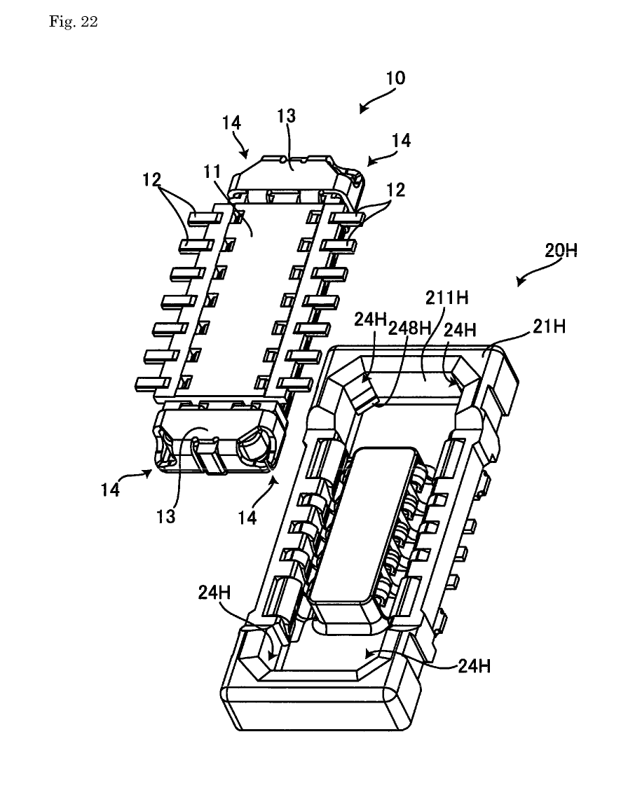

The receptacle connector 20H in the ninth embodiment shown in FIGS. 22-24(B) is different from the receptacle connectors of the first to eighth embodiments described above in such a point that it does not use any metal fitting latches. At the four corners of a plug connector receiving space 211H of a receptacle housing 21H, catching member receiving spaces 248H are shaped as to be sandwiched obliquely outward to an approximately rectangular shape of the plug connector receiving space 211H, and are formed as a shape of the receptacle housing 21H itself. That is, mating portions 24H are integrally formed in the receptacle housing 21H itself in the receptacle connector 20H of the ninth embodiment. The catching member receiving space 248H of the mating portion 24H is integrally formed in the receptacle housing 21H itself, in contrast to the catching member receiving space 242 of the first metal fitting latch 23 (see FIGS. 4(A),4(B)) used in the receptacle connector 20 in the above described first embodiment.

In the connector assembly of the ninth embodiment, the first arms 141 positioned on the first metal fitting catches 13 (see FIGS. 3(A),3(B)) of the plug connector 10 are fitted into the fitting-in recessed portions 248H of the mating portions 24H integrally positioned in the receptacle housing 21H. The first arms 141 engage the receptacle housing 21H itself.

In the ninth embodiment, the first arm 141 of the first metal fitting catch 13 used in the plug connector 10 is elastically deformed upon mating. Therefore, applications involving repetitive mating and unmating are suitable. However, since the mating portions 24H are integrally positioned on the receptacle housing 21H, repeated mating and unmating may wear down the mating portions 24H. Therefore, the ninth embodiment has a structure generally suitable for a connector assembly with a low frequency of mating and unmating requirement.

Though the various embodiments have been described above, each embodiment is related to a connector assembly configured such that mating of four corners of the plug connector is performed in an inclined direction along two sides forming a corner of the metal fitting catch, thus providing a lock mechanism that can withstand an impact from any direction.

It should be noted that the metal fitting catch and the metal fitting latch may have one catching member and one mating portion obtained by performing separation at central portions thereof.

Further, the use of the terms “first,” “second,” “third,” “fourth,” etc are not to be interpreted as establishing a priority, importance, or quantity of the various embodiments described. Rather, such terms are used to assist the reader in distinguishing between the various components and elements of the various embodiments.

What is claimed is:

1. A connector assembly comprising:
a first connector having
an approximate rectangular shape with
four corners, and
two parallel long sides connected together at the four corners by a pair of two parallel short sides, and
a catching member positioned on each of the four corners; and
a second connector complimentary to the first connector, having
mating portions at positions corresponding to the respective four corners of the first connector when the second connector is mated with the first connector, the mating portions being complimentary to the catching members, and when mated with the catching members, mate in a direction intersecting both the long and short sides intersecting at each of the four corners of the first connector.

2. The connector assembly according to claim 1, wherein the catching member is positioned on a metal fitting catch.

3. The connector assembly according to claim 1, wherein the first connector further comprises a first housing having a catching member positioned on each of the four corners.

4. The connector assembly according to claim 2, wherein mating portions are positioned on a metal fitting latch connected to the second connector.

5. The connector assembly according to claim 2, wherein the second connector further comprises a second housing having the mating portion positioned at the respective positions corresponding to each of the four corners of the first connector.

6. The connector assembly according to claim 2, wherein the first connector has a metal fitting catch positioned on each of the two short sides.

7. The connector assembly according to claim 6, wherein each metal fitting catch has
a base; and
two catching members, each extending from the base being positioned on an opposite corner.

8. The connector assembly according to claim 7, wherein each catching member has two cantilevered arms with fixed ends extending from the base and being positioned on the long side and the short side forming the corner.

9. The connector assembly according to claim 8, wherein the two cantilevered arms flank each corner, with opposite free ends extending outward from the base and extending towards each other.

10. The connector assembly according to claim 8, wherein each catching member has a recessed portion positioned adjacent to and extending between the fixed ends of the cantilevered arms.

11. The connector assembly according to claim 9, wherein the free ends of the two cantilevered arms are connected together, with the two cantilevered arms having a continuous annular shape.

12. The connector assembly according to claim 8, wherein the two cantilevered arms flank each corner, with opposite free ends being connected together by a catching wall extending obliquely across the corner of the metal fitting catch.

13. The connector assembly according to claim 12, wherein the catching wall is separated along a central portion by a separating space that divides the catching wall into two smaller catching wall sections, each catching wall section being connected to the free end of one of the two cantilevered arms.

14. The connector assembly according to claim 12, wherein each catching member has a recessed portion positioned adjacent to and extending between the fixed ends of the cantilevered arms.

15. The connector assembly according to claim 6, wherein each metal fitting catch has
a base; and
two cantilevered arms extending from the base at a fixed end, with one of the cantilevered arms being positioned at each of two opposite corners of the base.

16. The connector assembly according to claim 15, wherein an opposite free end of each cantilevered arm extends away at an angle from the base.

17. The connector assembly according to claim 16, wherein each cantilevered arm has a bent projection portion positioned proximate to the free end, and projection outward in a direction perpendicular to a surface of the base.

18. The connector assembly according to claim 16, wherein each cantilevered arm has a projecting pad disposed on an outer facing surface of the free end, projection outwardly from the outer facing surface.

19. The connector assembly according to claim 4, wherein the metal fitting latch has two mating portions positioned opposite to each other.

20. The connector assembly according to claim 19, wherein each mating portion has a latching wall positioned to face a corner of the first connector having the catching member.

21. The connector assembly according to claim 20, wherein each mating portion has a catching member receiving space positioned on a lower portion of the latching wall.

22. The connector assembly according to claim 20, wherein the latching wall is separated along a central portion by a separating space that divides the latching wall into two smaller latching wall sections.

23. The connector assembly according to claim 20, wherein the latching wall has a mating projection portion positioned on an inner facing surface.
